(19) United States
(12) Patent Application Publication
(10) Pub. No.: US 2014/0074644 A1
(43) Pub. Date: Mar. 13, 2014

(54) ON-LINE SALES SYSTEM USING A SOCIAL AUCTION

(71) Applicant: Ki-Won Nam, Seoul (KR)

(72) Inventor: Ki-Won Nam, Seoul (KR)

(21) Appl. No.: 14/116,736

(22) PCT Filed: May 10, 2012
(86) PCT No.: PCT/KR2012/003663

§ 371 Date: Nov. 8, 2013

(30) Foreign Application Priority Data
May 12, 2011 (KR) 10-2011-0044513
Aug. 23, 2011 (KR) 10-2011-0083735

(51) Int. Cl. G06Q 30/08

(52) U.S. Cl. CPC G06Q 30/08
USPC 705/26.3

(57) ABSTRACT

Disclosed is an on-line sales system using a social auction capable of giving an increased discount rate as time progresses to a reserved purchaser paying for products in part based on a future purchasing condition on products, providing a divided purchase ticket to participate in a social auction to the purchaser so as to make a bid one time only, activating a sale of participating companies by progressing the social auction, supporting an integrated successful bid price corresponding to a bid signal of a purchaser at the time of purchasing products, and activating a sale in an open market from which the divided purchase ticket is issued. According to the on-line sales system using a social auction, the seller sells the divided purchase ticket to assure a future sale, thereby easily securing production funds, implementing planned production, and effectively performing promotion and sales.

### BACKGROUND OF THE INVENTION

1. Field of the Invention

The present invention relates to an on-line sales system using a social auction, and more particularly, to an on-line sales system using a social auction capable of giving an increased discount rate as time progresses to a reserved purchaser paying for products in part based on a future purchasing condition on products, providing a divided purchase ticket to participate in a social auction to the purchaser so as to make a bid one time only, activating a sale of participating companies by progressing the social auction, supporting an integrated successful bid price corresponding to a bid signal of a purchaser at the time of purchasing products, and activating a sale in an open market from which the divided purchase ticket is issued.

2. Description of the Related Art

As known in the art, with the recent development of information communication technologies, a development of information providing technologies which provide information on various fields to multiple subscribers through at least one host server via a wide area data communication network in real time has been actively conducted.

In connection with this, a peripheral technology, such as a cache memory extension technology for more rapidly providing accurate information to subscribers, an information selection technology more conveniently accessing taste and preference of subscribers, and a compression technology are being developed. Further, attempts to develop various contents and a solution thereof based on these technologies have been continuously conducted.

Meanwhile, domestic and foreign on-line markets have rapidly grown. The on-line market may be largely divided into an on-line advertising market and an on-line shopping market. The on-line advertising market finally relates to advertisement for companies or products and therefore is indirectly associated with the shopping market, but is classified into a pure on-line advertising market and a shopping market.

The marketing in the on-line advertising market is mainly performed in two ways, such as how many customers the advertisement is exposed to and on how many valid customers an advertisement is effectively exposed to.

Therefore, the on-line advertising market and the shopping market expose the advertising or shopping information to more customers to allow the customers to purchase products. Therefore, various advertising techniques or shopping activation techniques have emerged.

A conventional advertising technique or shopping activation technique is a representative technique which provides a reserve to customers. That is, the technique provides a predetermined reserve to customers reading an advertisement or purchasing products to allow the customers to read more advertisements or purchase more products.

However, the conventional advertising technique does not give a large merit to individual customers because the reserve provided to individuals is very small. Therefore, the advertisement does not greatly contribute to the marketing of a seller or shopping activation.

Therefore, the conventional advertising technique may not effectively perform the promotion or sale of products even though a seller spends much on promotional costs to promote or sell products.

Further, an open market in which various sellers may freely sell products on one site has recently emerged. The open market is a market in which various sellers may upload their own product information for selling and act on behalf of sellers for payment of products, promotion of the open market, and the like to allow an open market operation company to divide and progress a part of their business to be performed by the sellers, thereby more conveniently performing a sale.

However, many open markets have emerged and therefore competition among the open markets is inevitably keen. When any open market is behind in the competition, the sale of sellers affiliated in the market is poor and therefore the open market requires a powerful promotional means.

### SUMMARY OF THE INVENTION

In consideration of the above-mentioned circumstances, it is an object of the present invention to provide an on-line sales system using a social auction capable of giving an increased discount rate as time progresses to a reserved purchaser paying for products in part based on a future purchasing condition on products, providing a divided purchase ticket to participate in a social auction to the purchaser so as to make a bid one time only, activating a sale of participating companies by progressing the social auction, supporting an integrated successful bid price corresponding to a bid signal of a purchaser at the time of purchasing products, and activating a sale in an open market from which the divided purchase ticket is issued.

In order to accomplish the foregoing objects, according to an aspect of the present invention, there is provided an on-line sales system using a social auction system, including: a purchaser terminal which generates a purchase signal of a divided purchase ticket for participating in an auction to receive a discount rate supported based on a future purchase for products and an auction participating signal; a seller terminal which performs an issuance request for issuing the divided purchase ticket based on the future sale to a purchaser, and registers a sale information on a product and sale conditions thereof; and a social auction service operation server configured to sell the divided purchase ticket issued by each seller as a social auction participating condition, register a purchaser information, generate auction numbers for each divided purchase ticket to register therein, and perform an auction process.

Preferably, the divided purchase ticket includes: a brand divided purchase ticket which stipulates a future purchase for a specific product; and a free divided purchase ticket which stipulates a future purchase for an unspecific product.

Preferably, the social auction participating condition includes a viewer who watches an advertisement at a specific time or for a specific product.

Preferably, the social auction uses a cost including at least one of a sale price of the brand divided purchase ticket and the free divided purchase ticket and a promotional cost of a seller as a financial resource of a successful bid price.

Preferably, the social auction service operation server is configured to register a successful bid discount rate of a brand product and a basic discount rate of the brand divided purchase ticket in an account of a successful bidder participating in an auction using the brand divided purchase ticket, and register a basic discount rate of the free divided purchase ticket and a successful bid discount rate converted into cash of the brand product in an account of a successful bidder participating in an auction using the free divided purchase ticket.

Preferably, the free divided purchase ticket is a purchase ticket to be used to purchases only the products of specific sellers previously registered in the social auction service operation server.

Preferably, the social auction service operation server is configured to generate a social auction number and provide the generated social auction number to the purchaser of the divided purchase ticket and allow a purchaser having the same social auction number to participate in the same auction and generate only a one-time bid signal in the same auction.

Preferably, the social auction service operation server is configured to register a setting information on the seller so as to determine that the social auction starting conditions are satisfied only when the number of purchasers of the brand divided purchase ticket is within a predetermined range, and determine whether an auction starts based on the registered setting information.

Preferably, the social auction service operation server is configured to convert all divided purchase tickets sold before the social auction starts into an accumulated discount rate for the specific products, and display the converted discount rate on a screen so that a purchaser confirms the converted discount rate.

Preferably, the social auction service operation server is configured to display an overall remaining accumulated discount rate updated by subtraction due to the generation of a successful bidder during the progress of the social auction on a screen so that the purchaser confirms the updated overall remaining accumulated discount rate.

Preferably, the brand divided purchase ticket or the free divided purchase ticket corresponds to a predetermined ratio of a sale price thereof to a sale price of a designated product.

Preferably, the seller registers an additional discount rate information in the social auction service operation server to provide an additional discount rate to each of the purchasers of the brand divided purchase ticket.

Preferably, the seller provides a cost for the specific number of sale products as the financial resource for the social auction, and the social auction service operation server is configured to previously designate and provide the specific number of sale products so that the successful bid processing on the specific number of sale products is performed within a limited discount range for each product.

Preferably, the purchaser registers a bid reservation information on the social auction in the social auction service operation server in advance.

Preferably, the social auction service operation server is set to allocate a first successful bid right to a successful bidder within a local range so that a purchaser residing in an area other than the local range is selected as a successful bidder when the successful bid fails more than a predetermined number of and process the auction, when the seller designates a local social auction.

Preferably, the social auction service operation server is configured to automatically increase the discount rate for the product as time progresses after the auction starts, determine that the successful bid for the discount rate is made depending on a user's selection signal for a specific discount rate, and subsequently increase the discount rate for a purchaser which has not generated a bid signal.

Preferably, the social auction service operation server is configured to automatically increase the discount rate for a product as time progresses after the auction starts, end the auction when a successful bid for the discount rate is made depending on the user's selection signal for the specific discount rate, and when the remaining accumulated discount rate is present, progress a new auction for a purchaser which has not generated a bid signal.

Preferably, the social auction service operation server is configured to continuously progress the social auction as long as the remaining discount rate continues to increase, and be updated, due to a successful bid.

Preferably, when the purchaser purchases the product with cash for a value for which the basic discount rate and the successful bid discount rate held by the successful bidder successfully bidding through the auction due to the free divided purchase ticket are converted, the social auction service operation server is configured to register a use limitation range for the discount rate of the seller by allowing the seller of the product to use the basic discount rate only within a previously limited discount rate, and compare the free divided purchase ticket information held in the purchaser account with the registered use limitation range and perform a subtraction processing based on the compared results.

Preferably, the social auction service operation server is configured to post a limitation of the discount price of the available free divided purchase tickets for each seller so that the purchaser reads the limitation.

Preferably, the divided purchase ticket has an expiration date set at the time of the issuance thereof.

Preferably, the social auction service operation server is configured to pay an additional discount price depending on a purchase frequency of the divided purchase tickets of each purchaser.

Preferably, the social auction service operation server is configured to provide a product package brand purchase ticket to which the discount rate is applied when products sold by a single company are simultaneously purchased, a company package brand purchase ticket to which the discount rate is applied when products sold by a plurality of companies are simultaneously purchased, and an area package brand purchase ticket to which the discount rate is applied when products of companies within a specific area are purchased.

Preferably, a selection of a seller participating in the product package brand purchase ticket, the company package brand purchase ticket, and the area package brand purchase ticket is determined by an agreement of other sellers participating together with them in the auction.

Preferably, the product package brand purchase ticket, the company package brand purchase ticket, and the area package brand purchase ticket have an independent discount price or discount rate applied thereto.

Preferably, the social auction service operation server is configured to replace the brand divided purchase ticket and the free divided purchase ticket depending on the agreement of the seller and the purchaser when all the accumulated discount rates for the brand divided purchase ticket and the free divided purchase ticket are not used up.

Preferably, the social auction service operation server is configured to sell the brand divided purchase ticket and the free divided purchase ticket successfully bidden at a specific discount rate to a new purchaser.

Preferably, the social auction service operation server is configured to approve an issuance of a gift divided purchase ticket for giving the brand divided purchase ticket and the free divided purchase ticket to a third party, and process a purchaser information together with an owner account information of the gift divided purchase ticket so as to equally apply the discount price applied to the purchase of the successful bidder at the time of the successful bid of the social auction to the purchaser using the gift divided purchase ticket.

Preferably, the social auction service operation server is configured to set a sale price of the divided purchase ticket, a promotional cost of the seller, and an advertising cost of an advertiser as the financial resource of the social auction, determine whether the successful bidder views advertisement for a product, and process the advertising costs to allocate an additional incentive to the successfully bidden discount price when the successful bidder views the advertisement.

Preferably, the social auction service operation server is configured to discount a price so that a predetermined number is sold at a preset discount price when the sale number set by the seller is sold at a normal price, and set both of fluctuation information and price determination variable information to alternately process a normal sale and a discount sale.

Preferably, the social auction service operation server is configured to act on the behalf of the sellers for products committed by the sellers.

According to the on-line sales system using a social auction of the embodiment of the present invention, the seller sells the divided purchase ticket to assure a future sale, thereby easily securing production funds, implementing planned production, and effectively performing promotion and sales. Further, the purchasers first pay for products in part to purchase the divided purchase ticket, thereby securing the right to participate in the social auction, challenging the winning of the accumulated discount rate so as to increase overall economic benefit, and not causing an economic loss even at the time of the failed bid.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram schematically illustrating a configuration of an on-line sales system using a social auction according to a first embodiment of the present invention;

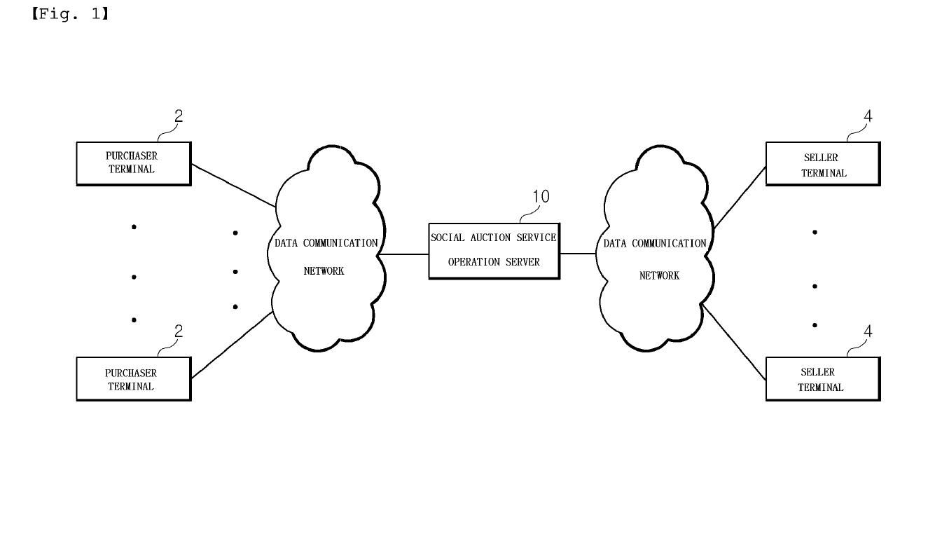

FIG. 2 is a block diagram schematically illustrating an operating principle of the on-line sales system using a social auction according to the first embodiment of the present invention;

FIG. 3 is a block diagram illustrating a configuration of a social auction service operation server included in the on-line sales system using a social auction according to the first embodiment of the present invention;

FIG. 4 is an exemplified diagram illustrating a sale of a divided purchase ticket using the on-line sales system using a social auction according to the first embodiment of the present invention;

FIG. 5 is an exemplified diagram illustrating known information on the divided purchase ticket included in the on-line sales system using a social auction according to the first embodiment of the present invention;

FIG. 6 is a diagram for describing a principle of the social auction using the on-line sales system using a social auction according to the first embodiment of the present invention;

FIGS. 7A and 7B are flow charts illustrating processing processes of the on-line sales system using a social auction according to the first embodiment of the present invention;

FIG. 8 is a flow chart illustrating processing processes on additional discount processing using the on-line sales system using a social auction according to the first embodiment of the present invention;

FIG. 9 is a flow chart illustrating processing processes of an on-line sales system using a social auction according to a second embodiment of the present invention;

FIG. 10 is a flow chart illustrating processing processes of an on-line sales system using a social auction according to a third embodiment of the present invention;

FIG. 11 is a flow chart illustrating processing processes of an on-line sales system using a social auction according to a fourth embodiment of the present invention;

FIG. 12 is a block diagram schematically illustrating an operating principle of an on-line sales system using a social auction according to a fifth embodiment of the present invention;

FIG. 13 is a flow chart illustrating processing processes of the on-line sales system using a social auction according to the fifth embodiment of the present invention;

FIG. 14 is a block diagram schematically illustrating an operating principle of an on-line sales system using a social auction according to a sixth embodiment of the present invention;

FIG. 15 is a flow chart illustrating processing processes of the on-line sales system using a social auction according to the sixth embodiment of the present invention;

FIG. 16 is a block diagram schematically illustrating an operating principle of a gift divided purchase right in circulation using on-line sales system using a social auction according to a seventh embodiment of the present invention;

FIG. 17 is a block diagram schematically illustrating a principle of an advertising scheme using on-line sales system using a social auction according to an eighth embodiment of the present invention;

FIG. 18 is a block diagram schematically illustrating an operating principle of a ninth system; and

FIG. 19 is a flow chart illustrating processing processes of the on-line sales system using a social auction according to the ninth embodiment of the present invention.

### DETAILED DESCRIPTION OF THE INVENTION

Hereinafter, preferred embodiments of the present invention will be described in detail with reference to the accompanying drawings.

In detail, in on-line sales system using a social auction according to a first embodiment of the present invention, considering only economic benefits given to purchasers, it is substantially similar to an existing coupon service. However, in a process of providing benefits to future reserved purchasers in advance, a successful bidder receives a possibility of having all product prices paid for by summing economic benefits divided into a plurality of reserved purchasers. Therefore, the on-line sales system using a social auction according to the first embodiment of the present invention is clearly different from the related arts in that a high expected value may be provided to the purchasers, a sale may be activated based on the high expected value, and planned production may be performed.

In more detail, economic benefits for the reserved purchasers performed by on-line sales system using a social auction according to the first embodiment of the present invention provides a possibility that products may be sold for a successful bid price which is enough to pay for all the products. This is a social auction method to allow purchasers' intention to select products, not merely a scheme of drawing of lots. The social auction is a scheme of progressing an auction for each auction number and increasing a discount rate as time progresses after the auction starts. When the auction progresses for each of the products, purchasers purchasing one divided purchase ticket may generate bid signals one time only.

Further, the one-time bid signal may be generated only when the remaining accumulated discount rate is present. For example, in the case in which the remaining accumulated discount rate is present 25%, the remaining accumulated discount rate becomes 0% when 100 persons generate bid signals at a discount rate of 25%. Therefore, when the accumulated discount rate is completely used up, no further bid signal is generated. Since the purchasers participating in the corresponding auction may not know whether to generate bid signals at what % the discount rate is, there may be a considerable risk that the purchasers blindly wait for only a high discount rate. The social auction will be described in more detail.

On-line sales system using a social auction according to the first embodiment of the present invention includes a purchaser terminal 2 for purchasing the divided purchase ticket and generating an auction participating signal to participate in an auction in which the discount rate may be supported based on the future purchase for products. The purchaser terminal 2 means a user's terminal which may generate a purchasing signal indicating intention to purchase the divided purchase ticket. The divided purchase ticket means a right to purchase products of a seller issuing the divided purchase ticket or pre-registered seller's products later and participate in a social auction progressed by the system according to the embodiment of the present invention.

Further, the on-line sales system using a social auction according to the first embodiment of the present invention includes a seller terminal 4 which requests an issuance of the purchasing ticket, registers product information for sale, and registers sale conditions to issue the divided purchase ticket based on the future sale to the purchasers; and a social auction service operation server 10 which sells the divided purchase tickets issued for each seller based on the social auction participating conditions, registers the purchaser information, generates and registers auction numbers for each of divided purchase tickets, and performs the auction processing.

In this case, the social auction service operation server 10 included in the on-line sales system using a social auction according to the first embodiment of the present invention is a server which approves the divided purchase ticket to be issued by the seller to act on the behalf of the issuance of the divided purchase ticket, processes the payment confirmation of the purchaser of the divided purchase ticket to sell the divided purchase ticket, and progresses the social auction which may generate a bid signal for the purchaser of the divided purchase ticket so as to select a successful bidder, and provides the successful bid price of the successful bidder.

In this case, the term divided purchase ticket means that sale prices are a predetermined ratio of a targeted article and the sale prices of the divided purchase tickets are summed and used as a financial resource of the social auction.

That is, when products, registered in the social auction service operation server 10 by a seller, to be sold in the future, are collectively worth 1,000,000 won, the seller may request the approval of the issuance of the divided purchase ticket to the social auction service operation server 10 and the social auction service operation server 10 may issue the divided purchase ticket for the combined goods. In this case, the sale price for each of the divided purchase tickets is a predetermined ratio (for example, 5% to 10%) of the sale price for 1,000,000 won worth of combined goods.

Further, the payment of the sale price for the divided purchase ticket is not taken by a seller and is used as a financial resource of the social auction. The seller progresses the social auction for the products to enable more purchasers to participate in the purchasing.

Meanwhile, in the scheme of progressing the social auction, the on-line sales system using a social auction according to the first embodiment of the present invention may utilize advertising costs paid by an advertiser for viewing an advertisement in view of a specific time or specific product, in addition to the sale price for the divided purchase ticket as the financial resource. In this case, viewers viewing the advertisement may participate in an auction.

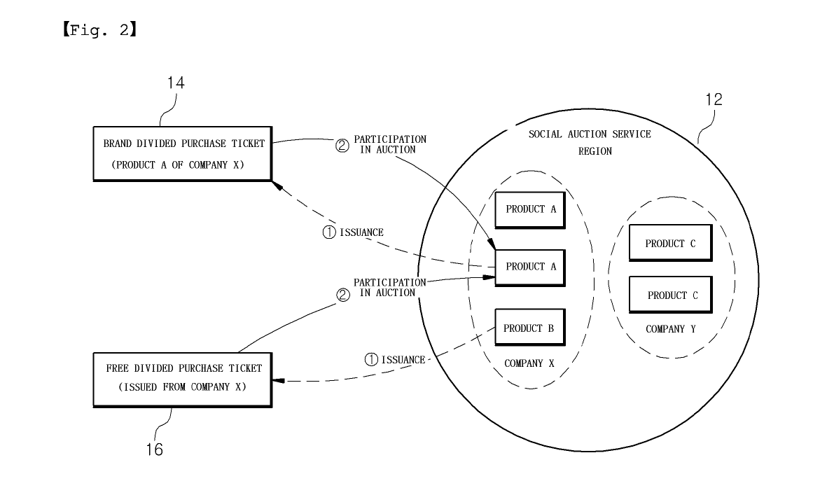

FIG. 2 is a block diagram schematically illustrating an operating principle of the on-line sales system using a social auction according to the first embodiment of the present invention.

Referring to FIG. 2, the divided purchase ticket which may be issued and distributed by on-line sales system using a social auction according to the first embodiment of the present invention is configured to include a brand divided purchase ticket 14 which stipulates the future purchase for specific products in advance and a free divided purchase ticket 16 which stipulates the future purchase for unspecific products in advance.

The social purchase service operation server 10 included in the on-line sales system using a social auction according to the first embodiment of the present invention enables the participating companies to issue the divided purchase ticket through the social purchase service, such that a social auction service region 12 may be provided.

The seller uploads and notifies information on the divided purchase ticket and information on sale conditions of the divided purchase ticket through the social auction service region 12 and the purchaser may recognize information on the divided purchase ticket, which may participate in the social auction, through the social auction service region 12. An example of the information may include information on the sale price for each of the divided purchase tickets, time and date of an auction, information on auction starting conditions, product information, information on pre-registered sale companies through which products may be purchased with the free divided purchase ticket, and the like.

In this case, the social auction is an auction in which the sale price for the brand divided purchase ticket or the free divided purchase ticket is a financial resource of the successful bid price and the purchaser may generate a one-time bid signal per a sheet of brand divided purchase tickets or free divided purchase tickets to the social auction service operation server 10 by using the purchaser terminal 2.

Meanwhile, the social auction service operation server 10 provides a discount rate of a purchase price for the brand products to a successful bidder participating in an auction using the brand divided purchase ticket and converts a discount rate of a successful bid price of the brand products into cash and registers the converted case in an account of the successful bidder participating in the auction with the free divided purchase ticket. Therefore, a personal account of the purchaser purchasing the free divided purchase ticket stores information on a basic discount rate (for example, 5%) of the free divided purchase ticket and successfully bidden and converted cash information.

That is, the brand divided purchase ticket is a purchase ticket which stipulates the future purchase for specific products in advance. Therefore, the social purchase service operation server 10 applies the discount rate of the successful bid price as the discounted price for the purchase price in case of purchasing the specific products designated in advance at the time of a successful bid through the social auction. Even though the specific products are not designated, the free divided purchase ticket is a purchase ticket which stipulates products of the pre-registered companies in the future. Therefore, the social auction service operation server 10 converts the discount rate of the successful bid price into cash at the time of a successful bid to register the converted cash in the account of the successful bidder.

Further, the free divided purchase ticket distributed by on-line sales system using a social auction according to the first embodiment of the present invention may not be used to purchase products of all the companies included in an open market provided by the system according to the embodiment of the present invention, but purchase only products of a specific seller which provides the products or the specific conditions of the specific seller registered in the social auction service operation server 10 in advance.

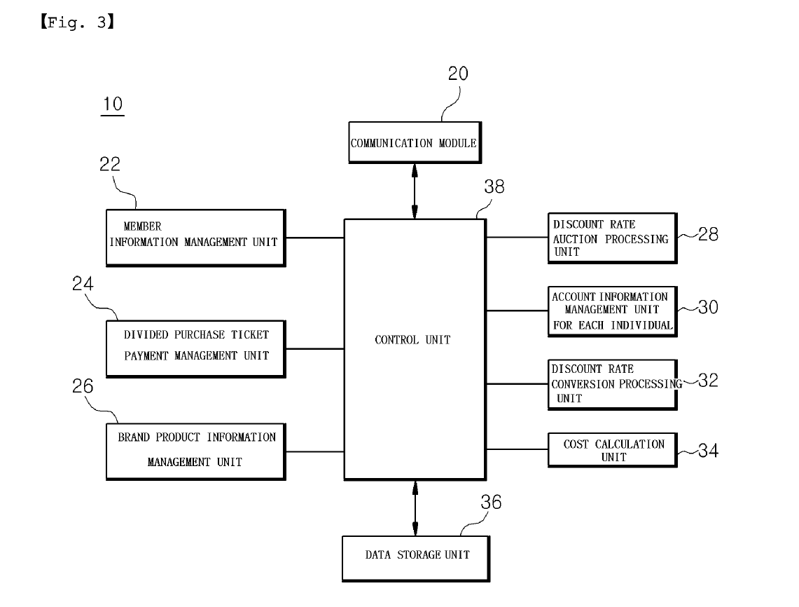

FIG. 3 is a block diagram illustrating a configuration of a social auction service operation server included in the on-line sales system using a social auction according to the first embodiment of the present invention.

Prior to describing the configuration of the social auction service operation server 10 included in the on-line sales system using a social auction according to the first embodiment of the present invention, the relationship between the social auction and the divided purchase ticket will be schematically described.

Referring to FIG. 3, in the social auction progressed by on-line sales system using a social auction according to the first embodiment of the present invention, the sale price for the brand divided purchase ticket or the free divided purchase ticket uses a price to a predetermined ratio of the sale price for the specific designated products as a financial resource. For example, a company selling specific products may issue the brand divided purchase ticket or the free divided purchase ticket and when the specific products are 1,000,000 won, 100,000 won becomes the sale price for the brand divided purchase ticket or the free divided purchase ticket if the predetermined ratio is assumed to be 10%.

Further, the sale price for the brand divided purchase ticket or the free divided purchase ticket becomes the financial resource of the social auction. Therefore, when 100 persons purchase the brand divided purchase ticket or the free divided purchase ticket for the product, a discount rate of 1,000% is used as the financial resource of an auction.

That is, the social auction service operation server 10 converts all of the divided purchase tickets sold before the social auction starts into the discount rate (for example, a discount rate of 1000%) for the specific products and displays the converted discount rate on a screen so that a purchaser may confirm the converted discount rate.

Further, the social auction service operation server performs a control to display an overall remaining discount rate updated after the discount rate is subtracted due to the successful bidder generated during the social auction.

In this case, the successful bidder means a purchaser who makes a bid with the discount rate fluctuating after the auction starts and purchases products with the discounted price corresponding to the discount rate at the time of a bid. A number of successful bidders are present in the single social auction and a purchaser having a brand divided purchase ticket or a free divided purchase ticket may participate in the social auction. The purchaser having the brand divided purchase ticket or the free divided purchase ticket may generate the one-time bid signal in the social auction.

Further, the social auction service operation server 10 included in the on-line sales system using a social auction according to the first embodiment of the present invention generates a social auction number and provides the generated social auction number to the purchaser of the divided purchase ticket. A purchaser having the same social auction number participates in the same auction and generates only a one-time bid signal in the same auction.

That is, the social auction in which the seller selling the specific products uses the generated brand divided purchase ticket or free divided purchase ticket to participate is a social auction associated with the seller and each purchaser in the social auction may generate only a one-time bid signal.

Further, when the seller participating in the on-line sales system using a social auction according to the first embodiment of the present invention sells his products to some degree, the seller may try to participate in the social auction with a plan to make a promotion. In this case, as described above, the sale price for the brand divided purchase ticket or the free divided purchase ticket is used as the financial resource of the social auction. However, even a purchaser failing to receive a successful bid for products may normally purchase products without financial losses by using the brand divided purchase ticket or the free divided purchase ticket. As a result, the successful bid price of the social auction becomes a price supported by the seller.

Therefore, only when the seller may sell products above a predetermined quantity, the seller may propose the auction starting conditions to progress the social auction. The information thereon is established in the social auction service operation server 10 in advance and thus may be published for a purchaser to confirm.

That is, the social auction service operation server 10 may register the setting information of the seller and determine whether the auction starts so as to determine that the social auction starting conditions are satisfied only when the purchaser number of the brand divided purchase ticket is within the predetermined range.

Meanwhile, describing the configuration of the social auction service operation server 10 with reference to FIG. 3, the social auction service operation server 10 includes a communication module, a member information management unit, a divided purchase ticket payment management unit, a brand product information management unit, a discount rate auction processing unit, an account information management unit for each individual, a discount rate conversion processing unit, a cost calculation unit, a data storage unit, and a control unit.

The communication module 20 communicates with the purchaser terminal 2 and the seller terminal 4 and the member information management unit 22 manages personal information on the purchaser and the seller.

Further, the divided purchase ticket payment management unit 24 manages the sale price for the divided purchase ticket which is used as the financial resource of the social auction and the brand product information management unit 26 registers and manages the product information which is a reference of the issuance of the divided purchase ticket.

Further, the discount rate auction processing unit 28 processes the social auction and includes an algorithm which processes an auction. According to the algorithm, the discount rate in a one-time auction may automatically increase as time progresses (for example, 0%, 2%, 4% . . . 10%) and each purchaser may generate the bid signal one time only in the auction. In this case, as long as the remaining accumulated discount rate is present, the auction discount rate is continuously increased until the discount rate becomes 100%.

Therefore, the discount rate auction processing unit 28 selects a purchaser generating a bid signal at a specific auction discount rate as a successful bidder when the remaining accumulated discount rate is present. When the remaining accumulated discount rate is present even after the discount rate of the successful bidder is subtracted, another purchaser may generate a bid signal at the specific auction discount rate. Therefore, when a one-time auction is progressed, a number of successful bidders may be generated, however, the number of successful bidders is not specified in advance.

Further, the account information management unit 30 for each individual manages the account information for each individual, such as a purchase history of the divided purchase ticket, successful bid information, and successful bid discount rate information converted into cash (only when a successful bid is made using a free divided purchase ticket) and the discount rate conversion processing unit 32 functions in the auction using the free divided purchase ticket to convert the successful bid discount rate into cash. In this case, the successful bid discount rate converted into cash is managed to be stored in accounts for each individual of successful bidders.

Consequently, in comparison to the brand divided purchase ticket, the free divided purchase ticket is not a purchase ticket which stipulates to purchase products of a specific seller in advance. Therefore, a successful bidder which has successfully bidden using a divided purchase ticket may pay a separate conversion commission when being converted into cash. By subtracting a predetermined commission, the free divided purchase ticket may have more disadvantages than the brand divided purchase ticket. Therefore, it is informed in advance that, to ensure that a purchaser of a brand divided purchase ticket has a fair chance, there are processes to remove the advantage that more various products can be purchased by a free divided purchase ticket.

Further, the cost calculation unit 34 calculates a sale price between an operation company and a seller and a commission, the data storage unit 36 stores social auction information, purchaser information, seller information, product sale information, and cost calculation information, and the control unit 38 controls each management unit or processing unit to register the information on each purchaser and seller, issue the divided purchase ticket, process the social auction, and calculate a sale price.

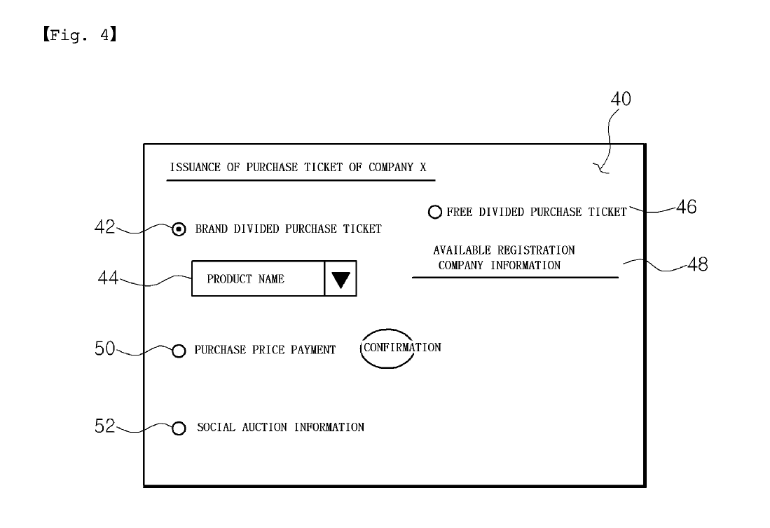

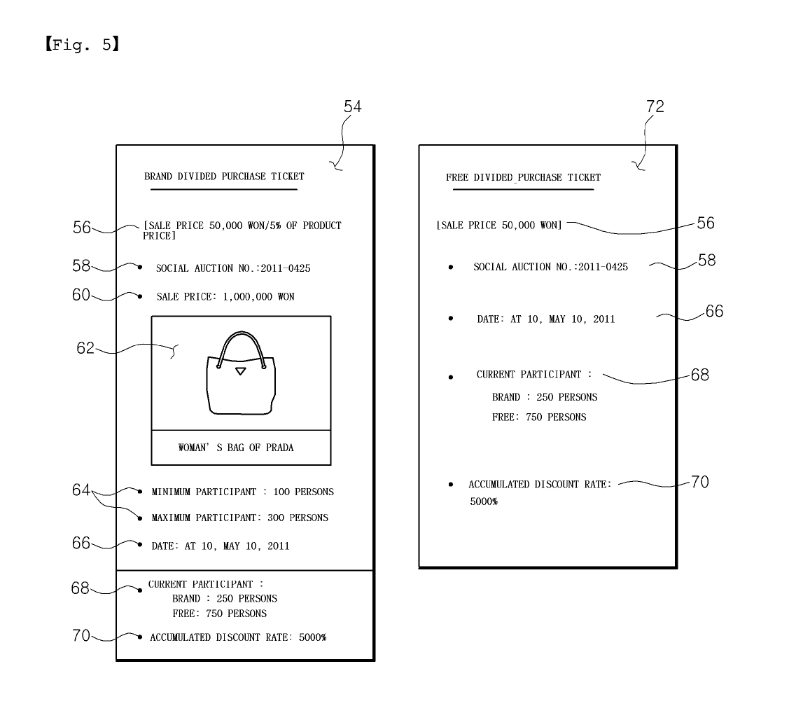

FIG. 4 is an exemplified diagram illustrating a sale of a divided purchase ticket using the on-line sales system using a social auction according to the first embodiment of the present invention, and FIG. 5 is an exemplified diagram illustrating known information on the divided purchase ticket included in the on-line sales system using a social auction according to the first embodiment of the present invention.

Referring to FIGS. 4 and 5, the divided purchase ticket is sold through on-line sales system using a social auction according to the first embodiment of the present invention and the sale price for the brand divided purchase ticket or the free divided purchase ticket forming the divided purchase ticket is used as a financial resource of a successful bid price, that is, a financial resource of a successful bid price of an auction.

That is, even though a user pays the sale price for the brand divided purchase ticket or the free divided purchase ticket based on a predetermined ratio for specific products as the sale price, the failed bidder may receive the discount as much as the price later. Consequently, the seller pays the financial resource of the successful bid price and the seller may instead secure a predetermined sale price in advance later.

Therefore, the social auction service operation server 10 preferably provides the on-line site through which the divided purchase ticket may be purchased. FIG. 4 is an exemplified diagram of the on-line site.

A divided purchase ticket purchasing region 40 is divided into purchasing regions 42 and 46 so that the purchaser may selectively purchase the brand divided purchase ticket or the free divided purchase ticket. The brand divided purchasing region 42 and the free divided purchasing region 46 include a selection column 44 which commonly selects a product name and an available registration company information 48 is linked with the free divided purchasing region 46.

That is, a company issuing the free divided purchase ticket may not accord with a company using the free divided purchase ticket and the sale price of the free divided purchase ticket is used as the financial resource of the social auction which progresses in a company issuing the free divided purchase ticket in advance. Therefore, a company supporting only the discount sale needs to be registered separately and the information thereof is provided to be confirmed by the purchaser.

However, even though the seller provides a discount rate of 5% to 10%, there is no reason that the seller wanting to sell more products rejects the purchaser wanting to purchase products using the free divided purchase ticket.

Meanwhile, the divided purchase ticket purchasing region 40 includes a selection button 50 for selecting a payment and a confirmation button 52 for confirming the social auction information.

Describing in detail the social auction information with reference to FIG. 5, the social auction information is divided into brand divided purchase ticket auction information 54 and free divided purchase ticket auction information 72. This information is to match a kind of purchase ticket with an auction. The seller selling the products based on specific products may issue the brand divided purchase ticket or the free divided purchase ticket and an auction number 58 is allocated and described to the issued brand divided purchase ticket or free divided purchase ticket. Therefore, the purchaser may simply confirm the auction information based on the auction number 58.

Further, information 56 on a sale price and a discount rate of the divided purchase ticket and information 60 on a sale price of products are described in the brand divided purchase ticket or the free divided purchase ticket, while a product display section 62, information 64 on the minimum number of participants and the maximum number of participants, information 66 on date and time of auction, information 68 on the number of auction participants, and information 70 on an accumulated discount rate are displayed on the brand divided purchase ticket.

If the price for 5% of the sale price is a sale price of the divided purchase ticket and the purchaser purchasing the divided purchase ticket is 1,000 persons, the accumulated discount rate which is the successful bid financial resource of an auction is 5,000%.

Therefore, the social auction service operation server 10 may provide a discount rate of the brand products to the successful bidder participating in an auction using the brand divided purchase ticket and convert the discount rate of the brand products into cash and registering the converted cash in the account of the successful bidder participating in the auction using the free divided purchase ticket.

Further, the social auction service operation server generates the social auction number and provides the generated social auction number to the purchaser of the divided purchase ticket and performs the process of allowing the purchaser having the same social auction number to participate in the same auction and generate only a one-time bid signal in the same auction.

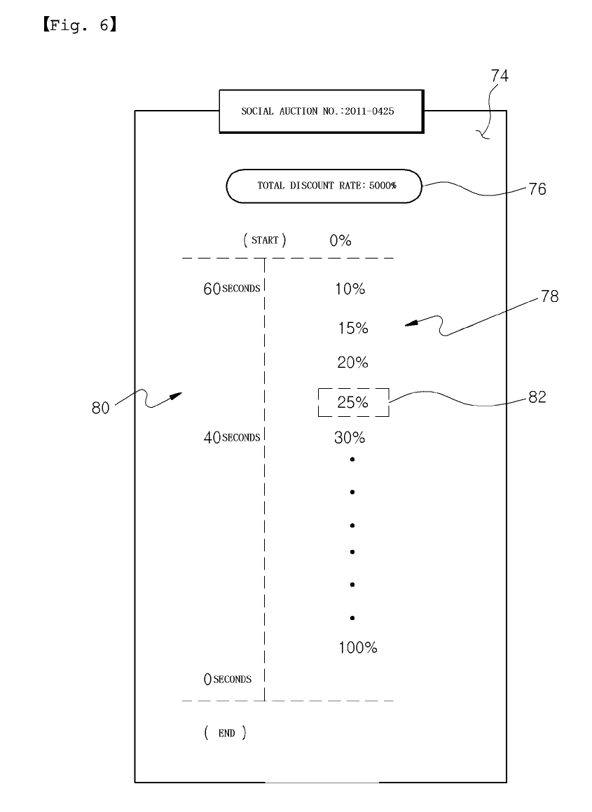

FIG. 6 is a diagram for describing a principle of the social auction using the on-line sales system using a social auction according to the first embodiment of the present invention.

Referring to FIG. 6, as described above, the social auction service operation server 10 progressing the social auction using the on-line sales system using a social auction according to the first embodiment of the present invention converts all divided purchase tickets sold before the social auction starts into the discount rate for the specific products and displays the converted discount rate on a screen so that the purchaser may confirm the discount rate.

That is, if the price for 5% of the sale price is a sale price of the divided purchase ticket and the number of purchasers purchasing the divided purchase ticket is 1,000 persons, the accumulated discount rate which becomes the successful bid financial resource of an auction is 5,000%, which is notified to the purchasers.

As illustrated in FIG. 6, the social auction using the on-line sales system using a social auction according to the first embodiment of the present invention includes an auction information window 74. A user may confirm total discount rate information 76, remaining time information 80, and discount rate fluctuation information 78 which are displayed on the auction information window 74. In this case, the algorithm is configured to increase the discount rate in the progress of time during the progress of the social auction.

For example, when any one of the purchasers first generates the bid signal at 2,500% during the progress of the social auction for the social auction number, the purchaser is a successful bidder, and thus acquires a right to receive the discount rate of 25% for the products.

In this case, any one of the purchasers may generate only a one-time bid signal in the auction, but may additionally generate the bid signal even when the remaining accumulated discount rate is present. Therefore, when the bid signals of a number of purchasers are generated at a previous discount rate of the discount rate waiting for the generation of the bid signal and thus the remaining accumulated discount rate is used up, since the purchasers who do not yet generate the bid signal may no more generate the bid signal, the purchaser may not blindly expect the high discount rate.

In this case, the social auction service operation server 10 displays on a screen the overall remaining discount rate, which is subtracted and updated due to the generation of the successful bidder during the progress of the social auction, so that the purchaser may confirm the overall remaining discount rate and regularly and automatically increases the discount rate for the products as time progresses. In this social auction, the social auction service operation server 10 performs the process of successfully bidding the discount rate depending on a user's selection signal for the specific discount rate.

Further, after the social auction service operation server 10 is used up due to the successful bid, the social auction is continuously progressed as long as the updated remaining discount rate is present. That is, when any one successful bidder receives a discount rate of 25% in the accumulated discount rate of 5,000%, the discount rate is continuously increased up to 100% as long as the remaining discount rate (for example, 4,975%) obtained by subtracting the successful discount rate is present. In this case, the social auction service operation server 10 continuously progresses an auction so that the purchasers who do not yet generate the bid signal may generate the bid signal one time only.

Meanwhile, even when the purchaser purchasing the brand divided purchase ticket or the free divided purchase ticket participating in the social auction by the on-line sales system using a social auction according to the first embodiment of the present invention does not receive the successful bid, the basic discount rate (for example, 10% of the specific product price) allocated to the brand divided purchase ticket and the free divided purchase ticket purchased by the purchaser may be used at the time of purchasing the products. Therefore, both of the failed successful bid information and the basic discount rate information are stored in accounts of each purchaser which are stored in the social auction service operation server 10.

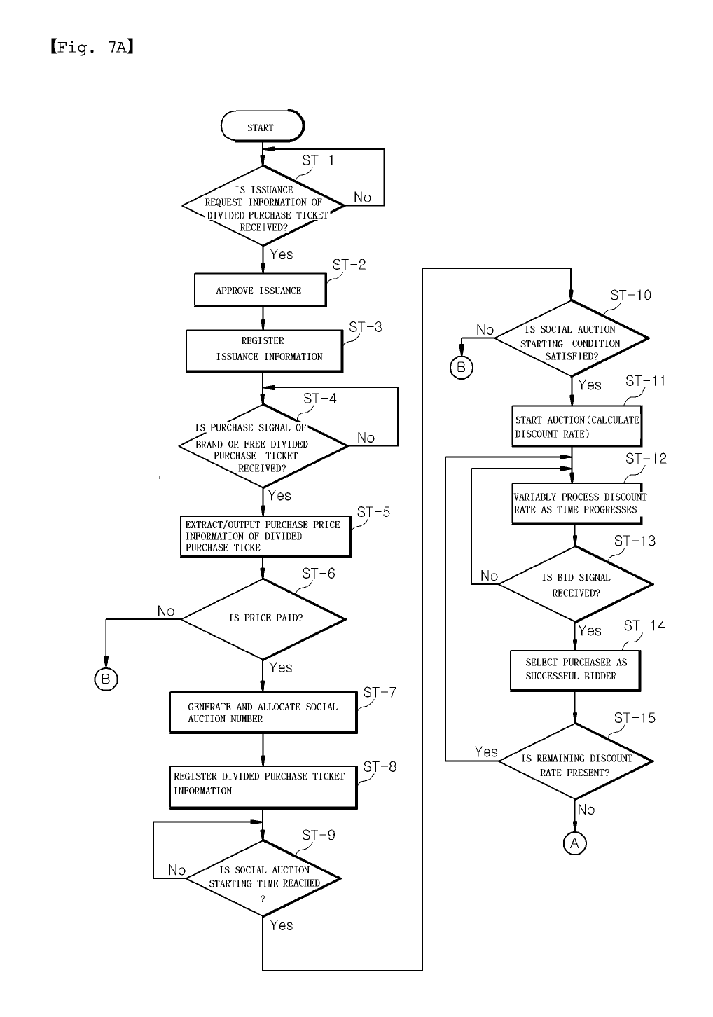

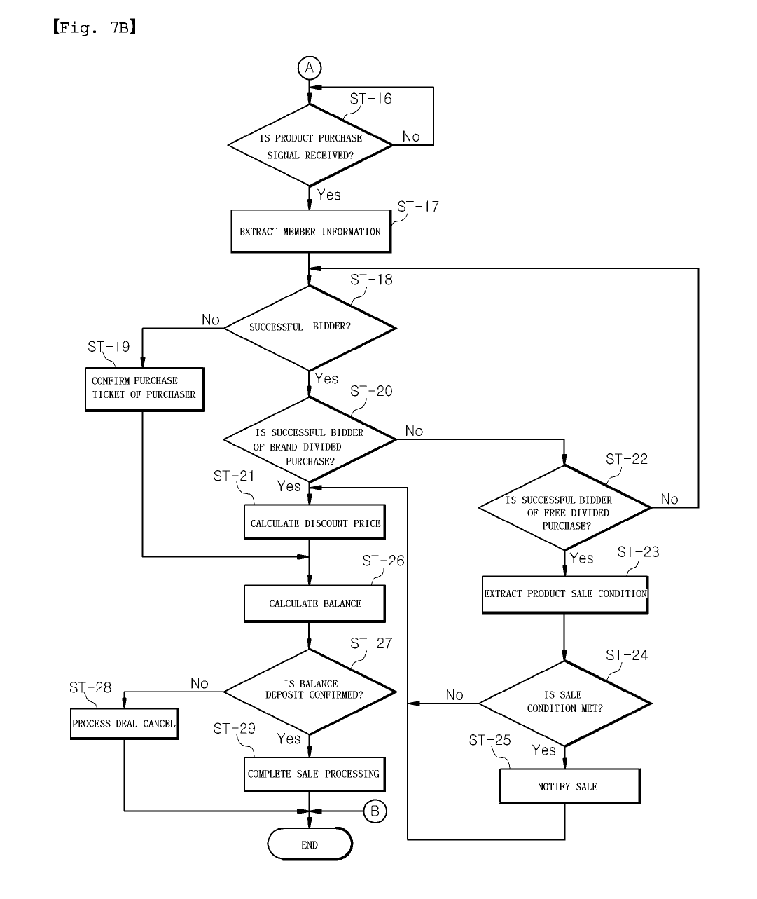

A function and an operation of the on-line sales system using a social auction according to the first embodiment of the present invention having the above-mentioned configuration will be described in detail with reference to the accompanying FIGS. 7A, 7B and 8.

FIGS. 7A and 7B are flow charts illustrating processing processes of the on-line sales system using a social auction according to the first embodiment of the present invention.

Referring to FIGS. 7A and 7B, the seller may join in the social auction service operation server 10 as a member using the seller terminal 4 and then upload the issuance request information on the divided purchase ticket to the social auction service operation server 10.

In this case, the social auction service operation server 10 determines whether the issuance request information on the divided purchase ticket is received from the specific seller terminal 4 and verifies the requested information to approve the issuance. The issuance request information includes specific brand information, information (discount rate information) on a sale price of the divided purchase ticket, and auction progress condition information.

When the issuance of the divided purchase ticket is approved, the issuance approval information is registered in the social auction service operation server 10.

In this state, the social auction service operation server 10 may directly sell the issuance approved divided purchase ticket on the site and links the site of the seller with the payment window to participate in sale. Consequently, the social auction service operation server 10 participates in payment and excludes the seller to prevent a financial accident.

In this state, when a purchase signal for the brand or free divided purchase ticket is received from any one purchase terminals 2, the social auction service operation server 10 extracts and outputs the divided purchase ticket information and determines whether payment for a sale price of the divided purchase ticket is made.

When the payment for a sale price of the divided purchase ticket is made, the social auction service operation server 10 generates a social auction number and registers the generated social auction number in the divided purchase ticket account of the purchaser and registers the purchase information on the divided purchase ticket.

Further, the social auction service operation server determines whether the auction starting time of the specific social auction number which may participate using the divided purchase ticket arrives and when the auction time arrives, determines whether the social auction starting condition is satisfied.

That is, since the social auction service operation server 10 has the auction condition information set by each seller registered therein, the social auction service operation server 10 determines whether the auction condition information satisfies the auction conditions for each auction number to decide whether the auction starts. As the auction starting conditions, there are whether the minimum number of set purchasers purchases the brand divided purchase ticket or whether there is the minimum number of set purchasers is present independent of the brand divided purchase ticket and the free divided purchase ticket. The social auction service operation server 10 may determine whether the auction starts depending on the auction conditions.

Meanwhile, when the social auction starts, the social auction service operation server 10 increases the discount rate (from 0% to 100%) in proportion to the passage time from the auction starting and outputs the discount rate information increasing in proportion to the passage time on the screen to allow a number of purchasers to confirm the information.

During the change in the discount rate, the social auction service operation server 10 determines whether the bid signal is received from the specific purchaser terminal 2. That is, the purchaser has a previously allocated auction number and any one purchaser may generate only a one-time bid signal during the progress of the auction. In this case, the purchaser may receive the discount rate as large as possible, but other purchasers first generate the bid signal at the previous discount rate to use up the accumulated discount rate. In this case, since the bid signal may be no more generated and the process of the auction ends, the purchaser may not blindly wait for the high discount rate.

Therefore, the social auction service operation server 10 increases the discount rate as time progresses after the auction starts and determines whether the bid signal is received from the specific purchaser to subtract the discount rate generated by the bid signal from the overall accumulated discount rate and determines whether the remaining accumulated discount rate is present after the subtraction. When the remaining accumulated discount rate is present, the social auction service operation server 10 allows the remaining purchasers to continuously progress the auction. Therefore, in this auction scheme, a number of successful bidder may be present in one-time auction and all the successful bid discount rates of each successful bidder may be different from each other.

Meanwhile, as another auction progressing scheme, the social auction service operation server 10 makes only one successful bidder for each auction be present and when the remaining accumulated discount rate is present, starts a new auction and enables the remaining purchasers to progress the new auction. This auction scheme is substantially similar to the scheme in which a number of successful bidders are present in a one-time auction as described above, but since only one successful bidder is present in a one-time auction, the progress time of auction is longer.

When in the auction system according to the first embodiment of the present invention, even though the successful bidder is generated, the purchasers who do not yet generate the bid signal continuously progress the auction, the discount rate at which the bid signal may be generated independent of the generation of the successful bidder is displayed by being changed from 0% to 100%.

On the other hand, similar to the case of the second auction in which only one successful bidder is present in a one-time auction, the discount rate is changed from 0% to 100% from the starting of the auction, but the discount rate is kept at the discount rate (for example, 25%) at the time when the bid signal is generated and the purchasers who do not yet generate the bid signal resume the new auction.

The continuous re-auction is continued until the overall accumulated discount rate is used up. The social auction service operation server 10 determines whether the remaining accumulated discount rate is present at the time of determining whether the re-auction is performed.

Meanwhile, the social auction service operation server allows the successful bidder to perform different processing depending on a kind of previously purchased divided purchase tickets at the time of processing the successful bid prices of each successful bidder. That is, when the specific purchaser owning the brand divided purchase ticket is a successful bidder, since the products to be purchased by the successful bidder are previously defined and the sale price for products is defined, the discount rate is applied as it is. For example, the discount rate of 30% may be applied at the time of purchasing the products by summing the discount rate (for example, 5% of the product price) corresponding to the purchase price of the brand divided purchase ticket and the discount rate (for example, 25%) at the time of a successful bid. The social auction service operation server 10 applies the acquired discount rate of 30% at the time of purchasing the previously designated specific products to perform the payment processing.

That is, the social auction service operation server 10 determines whether the purchaser of the purchaser terminal 2 generating the signal at the time of receiving the product purchasing signal is a successful bidder, and whether a brand divided purchase ticket is present in the account of the successful bidder. Based on this determination, the social auction service operation server 10 decides the discount rate (including the successful bid discount rate) related to the brand divided purchase ticket and calculates the balance to be finally paid based on the decided discount rate. When the deposit is made, the social auction service operation server 10 completes the sale processing of the products.

On the other hand, when the specific purchaser owning the free divided purchase ticket is a successful bidder, since the products to be purchased by the successful bidder are not previously defined, the purchaser may arbitrarily select and purchase the products of companies registered in the social auction service operation server 10. The auction progresses in the companies which issue the free divided purchase ticket, but since a price for products of other companies may be discounted and the products may be purchased, the discount rate (for example, 5% of a product price) corresponding to the purchase price of the free divided purchase ticket is used up due to the previous participation of auction from the viewpoint of the seller which does not yet issue the purchase ticket. Therefore, for example, the discount rate (for example, 5% of a product price) corresponding to the purchase price of the free divided purchase ticket is processes differently from the discount rate (for example, 25%) at the time of a successful bidding.

That is, the discount rate (for example, 5% of a product price) corresponding to the purchase price of the free divided purchase ticket may be applied as the discount rate at the time of purchasing a predetermined price of products only in companies which approves the discount rate and the discount rate (for example, 25%) which is successfully bidden at the auction may be used like cash.

In other words, when the products are registered in the social auction service operation server 10 to allow the seller to use a 100,000 won worth of products to a 10,000 won worth of free divided purchase ticket, if the purchaser holds a 5,000 won worth of free divided purchase ticket and the successful bid price of 10,000 won is present in the social auction, the purchaser may receive a discount of a total 15,000 won and pay only 85,000 won.

Therefore, since the seller may use the free divided purchase ticket of 10,000 won so as to purchase products, the seller may use one sheet of free divided purchase ticket most approaching 10,000 won among the free divided purchase tickets held by the seller or may use 10,000 won by summing several sheets of free divided purchase tickets. Consequently, the seller discount 5,000 won and receives 10,000 won of a purchaser account and 85,000 won paid by the purchaser, and thereby sells products for 95,000 won in total.

To this end, the social auction service operation server 10 needs to divide the discount rate information on the free divided purchase ticket and cash acquired due to the successful bid and register and manage the divided information and cash only in the account of the purchaser holding the free divided purchase ticket.

That is, the social auction service operation server determines whether the purchaser of the purchaser terminal 2 generating the signal at the time of receiving the product purchasing signal is a successful bidder, and whether the free divided purchase ticket is present in the account of the successful bidder. Based on this determination, the social auction service operation server 10 determines the price of free divided purchase tickets, and decides the discount price for the products of the seller to be purchased by the purchaser using the free divided purchase ticket and cash present in the account of the successful bidder. Then, the social auction service operation server 10 calculates the balance to be finally paid based on the decided discount price and cash and completes the sale processing depending on whether the deposit is made.

FIG. 8 is a flow chart illustrating processing processes on additional discount processing using the on-line sales system using a social auction according to the first embodiment of the present invention.

Referring to FIG. 8, the seller using the on-line sales system using a social auction according to the first embodiment of the present invention may want the purchaser to previously determine the future purchase for the seller's products. Further, the purchaser of the brand divided purchase ticket may want to receive more benefits than the purchaser of the free divided purchase ticket.

Therefore, the seller using the on-line sales system using a social auction according to the first embodiment of the present invention may provide an additional discount rate to the purchaser of the brand divided purchase ticket, register the additional discount rate information in the social auction service operation server 10, and may apply the registered discount rate information at the time of purchasing the products.

That is, at the time of receiving the purchase signals of the specific products, the social auction service operation server 10 determines whether the brand divided purchase ticket is present in the account of the purchaser and decides the discount rate (including the successful bid discount rate) related to the brand divided purchase ticket. The social auction service operation server 10 further determines whether the additional discount rate of the seller is present in the account of the purchaser, and calculates the balance to be finally paid. When the deposit is made, the social auction service operation server 10 completes the sale processing of the products.

Functions and operations of the on-line sales system using a social auction according to the other embodiments of the present invention will be described in detail with reference to the accompanying drawings.

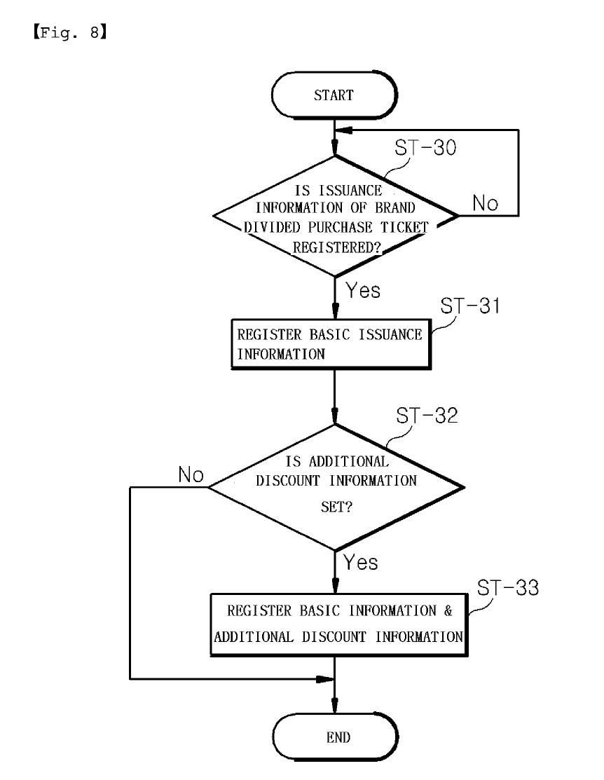

FIG. 9 is a flow chart illustrating processing processes of an on-line sales system using a social auction according to a second embodiment of the present invention.

Referring to FIG. 9, in the on-line sales system using a social auction according to the second embodiment of the present invention, the seller may provide the discount rate of products as the promotional costs and may progress the same auction as the first embodiment of the present invention using the discount rate as the financial resource.

That is, in the on-line sales system using a social auction according to the second embodiment of the present invention, the seller may unilaterally provide the financial resource of auction. In this case, the scheme of providing the financial resource of auction may be classified into two schemes.

One scheme designates the number of products to be sold while providing the discount rates (for example, a maximum of 30%) for each product. This scheme does not define the discount price provided by the seller and determines the discount price depending on the discount rate successfully bidden in the overall auction. Herein, the number of products is equal to the total number of auctions.

That is, when the seller provides 100 products and sets the successful bid discount rate not to exceed 30%, the social auction service operation server 10 registers the information to limit the discount rate increasing in proportion to the passage time at the time of the starting of the auction not to exceed 30%. In this case, as a result of progressing the auction 100 times within the range of the discount rate, when the average discount rate is determined to be 20%, the social auction service operation server 10 may determine that the seller uses the discount rate of 2,000% as the promotional costs. In summary, this scheme is the same as the case in which the seller uses 20 products as the promotional costs, but considering the margin (for example, assumed that the margin is 50%), is the same as the case in which the seller uses 10 products as the promotional costs.

Another scheme allows the seller to provide the cost for the predetermined number of products as the promotional costs and does not limit the successful bid discount rates for each product.

That is, this scheme is a scheme of setting the accumulated discount rate of the auction to 2,000% when the seller provides 20 products as the promotional costs and continuously repeating the auction until the discount rate 2,000% is completely used up. Therefore, the social auction service operation server 10 determines whether the remaining accumulated discount rate is present and subtracts the successful bid discount rate based on the remaining accumulated discount rate, and then updates the accumulated discount rate information when the renewed remaining accumulated discount rate is present to continuously progress the auction.

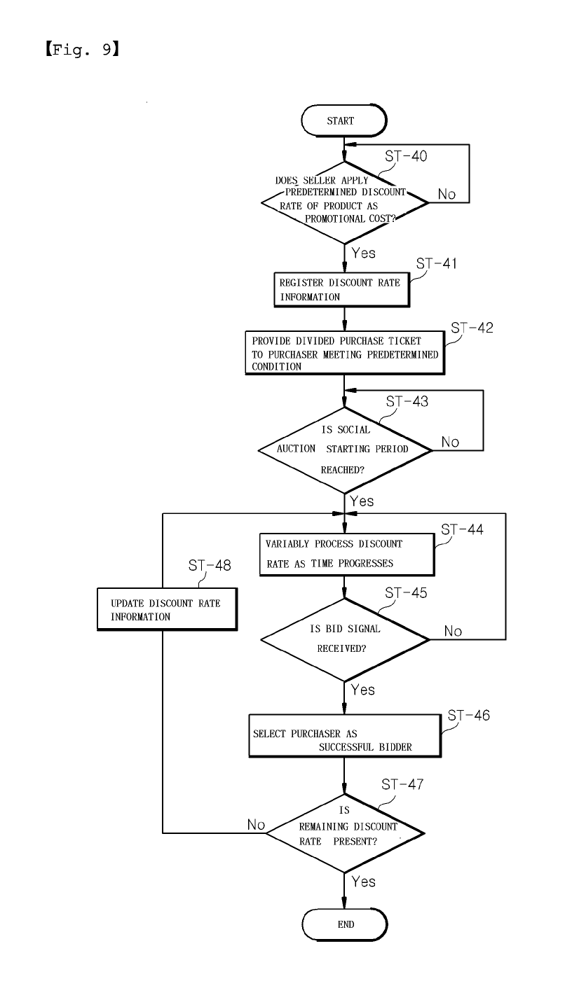

FIG. 10 is a flow chart illustrating processing processes of an on-line sales system using a social auction according to a third embodiment of the present invention.

Referring to FIG. 10, in the on-line sales system using a social auction according to the third embodiment of the present invention, when the purchaser may not directly generate the bid signal, the purchaser may register bid reservation information in the social auction service operation server 10 in advance before the auction starting time.

That is, the bid reservation information is stored in the social auction service operation server 10, along with the divided purchase ticket information. At the time of starting the auction having a specific number, the social auction service operation server 10 allows the purchaser to automatically determine whether the discount rate reaches the previously designated bid discount rate and at the time of reaching, allows the purchaser to automatically generate the bid signal at a time when the previously designated bid discount rate is arrived.

When the auction ends, the social auction service operation server 10 deletes the bid reservation information stored in the personal account.

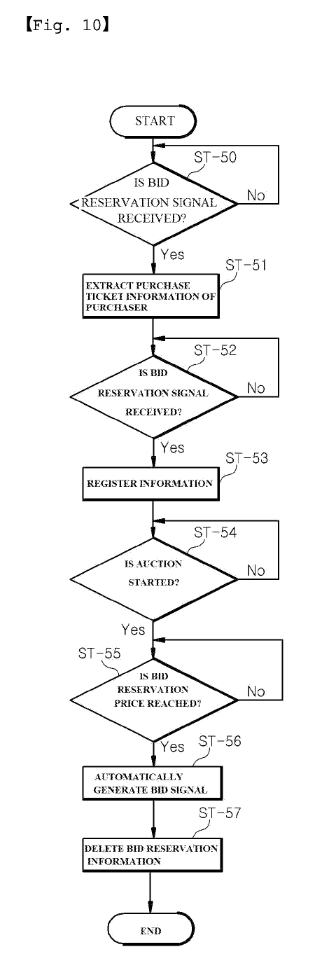

FIG. 11 is a flow chart illustrating processing processes of an on-line sales system using a social auction according to a fourth embodiment of the present invention.

Referring to FIG. 11, the on-line sales system using a social auction according to the fourth embodiment of the present invention is a system which can provide a local incentive or a local penalty to the successful bidder.

That is, when the seller designates a local social auction, the social auction service operation server 10 may select a successful bidder residing at an area other than the local range as the successful bidder when the successful bid has failed more than a predetermined number of times, but may progress the auction by being set to allocate a first successful bid right to the successful bidder within a local range.

For example, the social auction service operation server 10 determines whether the seller designates the local social auction, notifies that the auction is the local social auction when the seller designates the local social auction and then starts the auction. The social auction service operation server 10 determines whether the purchaser is a purchaser within the local range at the time of receiving the bid signal, and then if it is determined that the purchaser is not a purchaser within the local range, determines whether the successful bidder is the failed bidder one times or more, and performs the successful bid processing only when the successful bidder is the failed bidder one times or more.

On the other hand, when the purchaser generating the bid signal is the purchaser within the local range, the social auction service operation server 10 processes the purchaser as the successful bidder.

Therefore, the on-line sales system using a social auction according to the fourth embodiment of the present invention may provide the local incentive or the local penalty to the successful bidder.

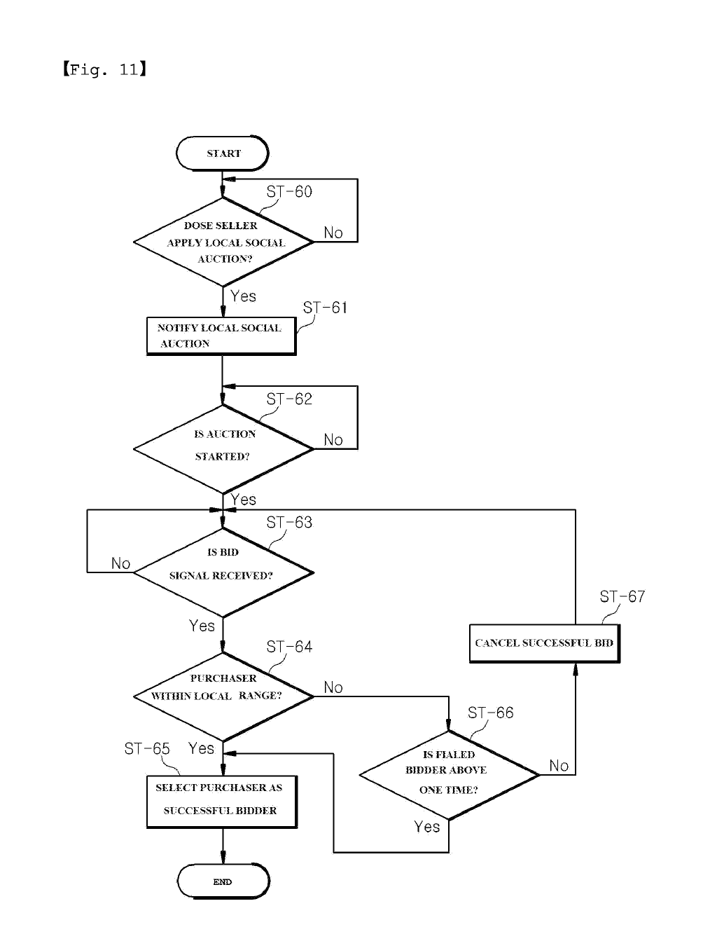

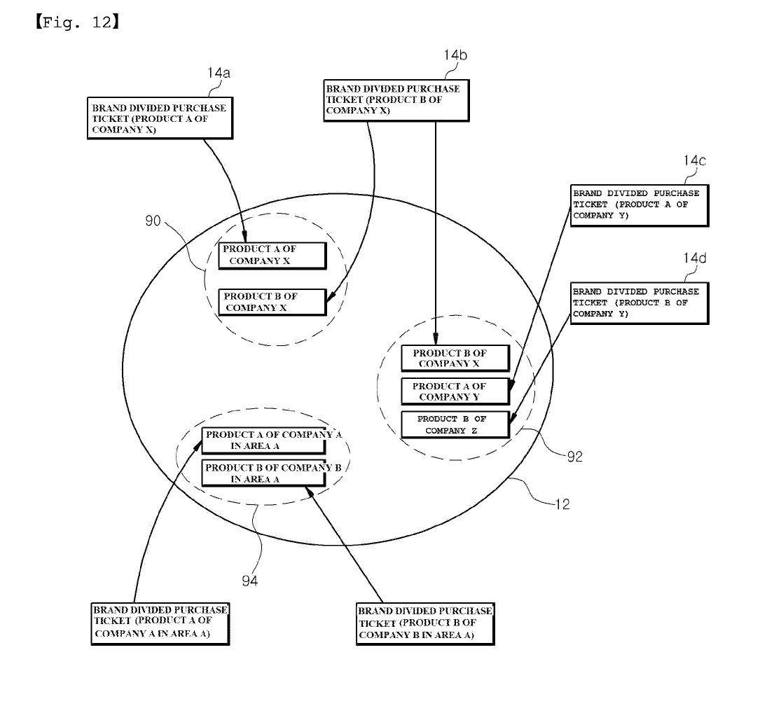

A function and an operation of an on-line sales system using a social auction according to a fifth embodiment of the present invention will be described in detail with reference to the accompanying FIGS. 12 and 13.

FIG. 12 is a block diagram schematically illustrating an operating principle of the on-line sales system using a social auction according to the fifth embodiment of the present invention.

Referring to FIG. 12, the on-line sales system using a social auction according to the fifth embodiment of the present invention sells the divided purchase ticket as a package form and provides additional incentives such as more discount benefits to the purchaser purchasing the package divided purchase ticket at the time of a successful bid, or the like. According to the on-line sales system using a social auction according to the fifth embodiment of the present invention, the purchaser having purchase intention of any one of a plurality of products may use as a sale activation means the fact that a frequency of purchasing products as a package is larger.

In this case, according to the embodiments of the present invention as described above, the social auction service operation server 10 described above is a server of approving the issuance of the package brand purchase ticket. Preferably, the package brand purchase ticket may issue the same package brand purchase ticket depending on the agreement of the sellers who are an issuance subject.

Further, the package purchase ticket does not include a package free purchase ticket. Since the free purchase ticket has liquidity and need not to compulsorily purchase the specific products, the free purchase ticket is grouped as the package to simultaneously purchase products of specific companies or need not have an obligation to simultaneously purchase products of different companies.

Therefore, the package purchase ticket is issued as the brand purchase ticket form. Herein, the package brand purchase ticket provided in the social purchase service region 12 may be classified into a product package brand purchase ticket 90 which may sell a plurality of products sold by a single company, a company package brand purchase ticket 92 which may simultaneously sell products sold by a plurality of companies; and an area package brand purchase ticket 94 which may simultaneously sell products of companies in a specific area.

For example, the product package brand purchase ticket 90 is a brand purchase ticket which sets purchasing both a plurality of products sold by the single company, for example, product A of company X and product B of company X as obligation requirements.

As a result, the product package brand purchase ticket 90 may be considered as the integrated brand purchase ticket of a brand purchase ticket 14a which purchases product A of company X and a brand purchase ticket 14b which purchases product B of company X. According to the product package brand purchase ticket 90, the purchaser may receive a discount price larger than the discount price obtained at the time of purchasing the brand purchase ticket 14a which purchases product A of company X and the brand purchase ticket 14b which purchases product B of company X, respectively.

Further, the company package brand purchase ticket 92 is a brand purchase ticket which enables a plurality of companies to simultaneously sell different products, for example, may be a brand purchase ticket which sets purchasing both product A of company Y and product B of company Z as the obligation requirements.

As a result, the company package brand purchase ticket 92 may be considered as the integrated brand purchase ticket of a brand purchase ticket 14c which purchases product A of company Y and a brand purchase ticket 14d which purchases product B of company Z. According to the company package brand purchase ticket 92, the purchaser may receive a discount price larger than the discount price obtained at the time of purchasing the brand purchase ticket 14c which purchases product A of company Y and the brand purchase ticket 14d which purchases product B of company Z, respectively.

Meanwhile, the area package brand purchase ticket 94 is a brand purchase ticket which compulsorily purchases products of companies located in a predetermined zone, for example, a plurality of products. The area package brand purchase ticket 94 is a brand purchase ticket which may be issued by the open market (for example, East Gate market, or South Gate market in Korea) such a large-scale apparel center, the open market (for example, Ebay shopping mall) on e-commerce, or the like.

In this case, the product package brand purchase ticket 90, the company package brand purchase ticket 92, and the area package brand purchase ticket 94 are each applied with an independent discount price or discount rate. Preferably, the discount price or the discount rate is increased in proportion to the number of products sold or the number of companies.

Meanwhile, the selection of the seller participating in the issuance of the product package brand purchase ticket 90, the company package brand purchase ticket 92, and the area package brand purchase ticket 94 is determined by the agreement of other participating sellers altogether. Further, the participating request or reading for the package brand purchase ticket is made by the social auction service operation server 10.

FIG. 13 is a flow chart illustrating processing processes of the on-line sales system using a social auction according to the fifth embodiment of the present invention.

Referring to FIG. 13, the seller first transmits the participating request information on the specific package brand purchase ticket to the social auction service operation server 10 included in the on-line sales system using a social auction according to the fifth embodiment of the present invention through the seller terminal 4.

Next, the social auction service operation server 10 registers the participating request information on the package brand purchase ticket to allow other sellers to read it. For example, the participating request information may include information on companies, areas, products, and the like.

Therefore, other sellers access the social auction service operation server 10 to read the participating request information on the waiting package brand purchase ticket and make the issuance request of the package brand purchase ticket to the participating request information which seems to become their companies.

Next, the social auction service operation server 10 uploads the participating request information on the package brand purchase ticket based on the issuance request information on the brand purchase ticket uploaded by other sellers and transmits the information to the waiting sellers. Therefore, by the approval of the seller, the social auction service operation server 10 determines that the issuance requirements of the package brand purchase ticket is satisfied and sets the information on the package brand purchase ticket so that the purchaser reads and registers the information.

Further, the social auction service operation server 10 issues and provides the package brand purchase ticket so that the purchaser may purchase the package brand purchase ticket.

When any one seller does not agree the issuance of the package brand purchase ticket, the social auction service operation server 10 determines that the sellers do not satisfy the requirements of issuing the same package brand purchase ticket and transmits the information to the opponent seller terminal 4.

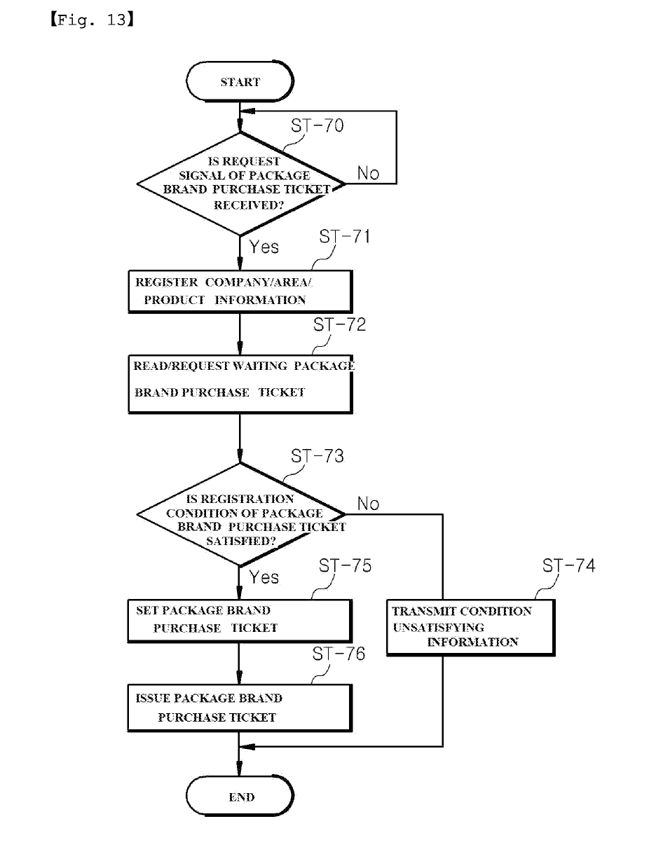

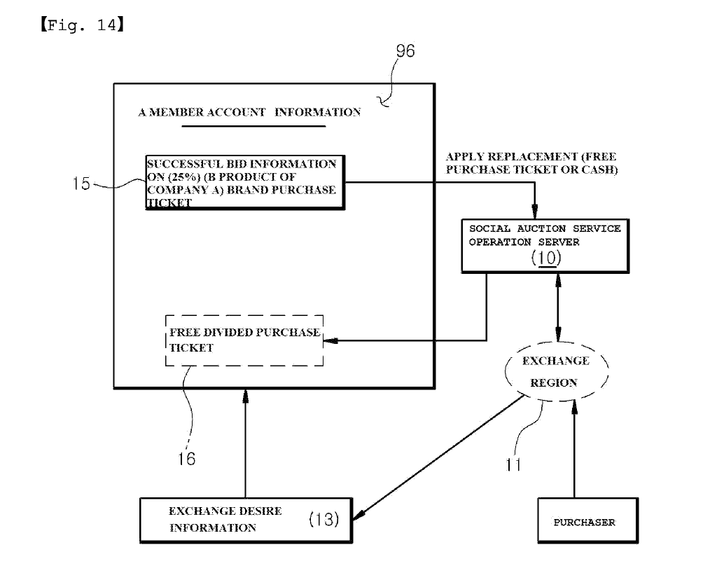

A function and an operation of an on-line sales system using a social auction according to a sixth embodiment of the present invention will be described in detail with reference to the accompanying FIGS. 14 and 15.

FIG. 14 is a block diagram schematically illustrating an operating principle of the on-line sales system using a social auction according to the sixth embodiment of the present invention, and FIG. 15 is a flow chart illustrating processing processes of the on-line sales system using a social auction according to the sixth embodiment of the present invention.

Referring to FIGS. 14 and 15, the on-line sales system using a social auction according to the sixth embodiment of the present invention is operated to exchange the brand divided purchase ticket 14 and free divided purchase ticket 16 in circulation or exchange cash between the purchaser and the seller.

The brand divided purchase ticket is a purchase ticket which may receive a predetermined price based on the purchase conditions of specific products in the future and participate in the social auction which may receive larger price. The brand divided purchase ticket 14 prior to participating in the social auction allows the purchaser to pay the penalty for the discount price of the purchase ticket itself and thus may be exchanged into cash or exchanged into the brand divided purchase ticket or the free divided purchase ticket which are held by other purchasers. However, even in this case, the penalty to be paid to operation companies or other purchasers may be preferably paid by the purchaser which exchanges the purchase ticket.

The brand divided purchase ticket 15 which makes the successful bid to receive the purchase discount price for the specific products by participating in the social auction may allow unspecific users to express the purchase intention and may perform the exchange when the agreement on the purchase price is made among them.

That is, the social auction service operation server included in the on-line sales system using a social auction according to the sixth embodiment of the present invention is provided with an exchange region 11 which posts information required for the exchange of the brand divided purchase ticket or the free divided purchase ticket or the cash exchange and supports the processing such as the payment to perform a deal.

The exchange region 11 is linked with account information 96 of a member to make the deal for the brand divided purchase tickets 14 and 15 or the free divided purchase ticket 16. The deal processing is performed by the social auction service operation server 10.

Further, the purchasers requesting the deal to the brand divided purchase tickets 14 and 15 or the free divided purchase tickets 16 using the social auction service operation server 10 upload exchange desire information 13 to the server and post the same.

Meanwhile, since the free divided purchase ticket has the same value as cash prior to participating in the social auction, only the predetermined operation penalty is paid and the cash exchange is made, by the social auction service operation server 10. However, since the free divided purchase ticket participating in the social auction in advance uses the discount price held by the free divided purchase ticket as the financial resource of the social auction, when the penalty above the discount price is paid, the cash exchange may be made.

Further, the exchangeable time of the free divided purchase ticket may be limited during the progress of the social auction. That is, since the financial resource which may be successfully bidden remains during the progress of the social auction, the discount price (for example, 5%) of the free divided purchase ticket is used up before all the financial resources of the successful bid are used up and thus the free divided purchase ticket may be configured to be exchanged.

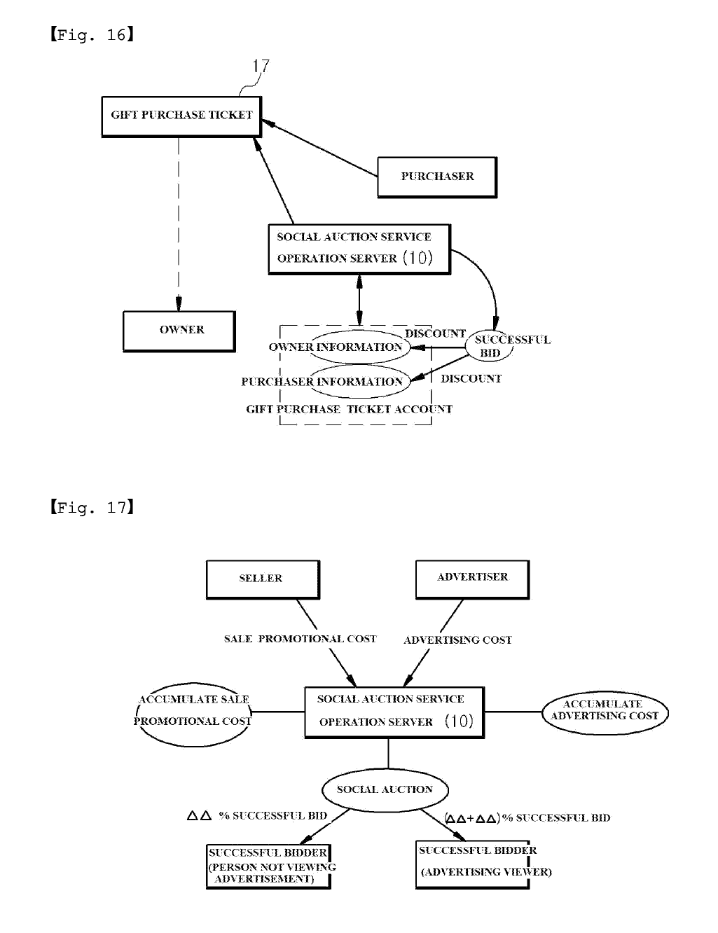

A function and an operation of an on-line sales system using a social auction according to a seventh embodiment of the present invention will be described in detail with reference to the accompanying FIG. 17.

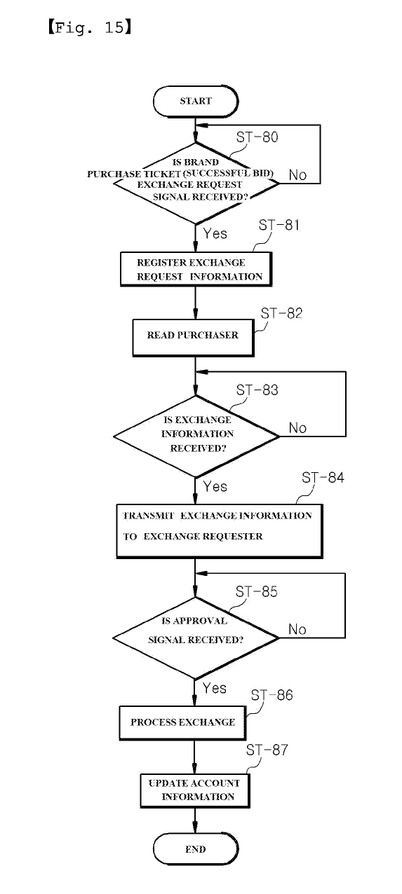

FIG. 16 is a block diagram schematically illustrating an operating principle of a gift divided purchase right in circulation using the on-line sales system using a social auction according to the seventh embodiment of the present invention.

Referring to FIG. 16, the on-line sales system using a social auction according to the seventh embodiment of the present invention may distribute the brand divided purchase ticket and the free divided purchase ticket through the distribution means referred to as a gift divided purchase ticket.

That is, the brand divided purchase ticket and the free divided purchase ticket may be distributed as a gift purpose.

In this case, in the on-line sales system using a social auction according to the seventh embodiment of the present invention, in order to increase the distribution efficiency, the social auction service operation server 10 performs processing to allow a purchaser purchasing a gift purchase ticket 17 to share benefits of the successful bid of the social auction.

That is, the gift purchase ticket 17 is a term specifying the purchase ticket when the brand divided purchase ticket and the free divided purchase ticket are distributed as the gift purpose, but equally performs the social auction processing for the brand divided purchase ticket and the free divided purchase ticket. However, in the case of the gift purchase ticket 17, the benefits of the discount price provided to the owner successfully bidden in the social auction are equally provided to the purchasers and thus the distribution performance is increased.

Herein, the social auction service operation server 10 exchanges the value of the discount price benefits provided to the purchaser into cash. Preferably, since the seller which may provide the distribution benefits may provide costs for the purchasers, the server may limit the gift purchase ticket 17 for the brand divided purchase ticket.

As described above, the social auction service operation server 10 needs to provide the financial benefits to the owner and the purchaser of the gift purchase ticket 17 after the social auction is started. Therefore, the owner information and the purchaser information are managed by being linked with the information of each gift purchase ticket 17.

In more detail, the social auction service operation server 10 approves the issuance of the gift divided purchase ticket 17 for giving the brand divided purchase ticket or the free divided purchase ticket to a third party and process the purchaser information together with the owner account information of the gift divided purchase ticket so that the discount price applied to the purchase of the successful bid may be equally applied to the purchaser at the time of the successful bid of the social auction through the gift divided purchase ticket 17.

Next, a function and an operation of an on-line sales system using a social auction according to an eighth embodiment of the present invention will be described in detail with reference to the accompanying FIG. 17.

FIG. 17 is a block diagram schematically illustrating a principle of the advertising scheme using the on-line sales system using a social auction according to the eighth embodiment of the present invention.

Referring to FIG. 17, as the financial resources of the successful bid price of the social auction of the on-line sales system using a social auction according to the eighth embodiment of the present invention, the advertising costs of an advertiser may be added, as well as the promotional costs of the seller.

That is, the foregoing social auction is configured to be supported as the discount price at the time of the successful bid with the promotional costs provided by the seller, however on-line sales system using a social auction according to the eighth embodiment of the present invention additionally provides the advertising costs of specific advertisers in addition to the sum of the discount price provided at the time of the successful bid.

In this case, the social auction service operation server 10 included in the on-line sales system using a social auction according to the eighth embodiment of the present invention sets the sale price of the divided purchase ticket, the promotional costs of the seller, and the advertising costs of the advertiser as the financial resource of the social auction. Then, the social auction service operation server 10 determines whether the successful bidder views advertisement, and processes the advertising costs to allocate the additional incentive to the successfully bidden discount price when the successful bidder views advertisement.

That is, when the social auction service operation server 10 supports the discount price to the successful bidder while monitoring the data on whether the successful bidder views the advertisement, the social auction service operation server 10 is set to further support the advertising costs together with the successfully bidden discount price when the advertising viewing history is present and support only the successfully bidden discount price when the advertising viewing history is not present.

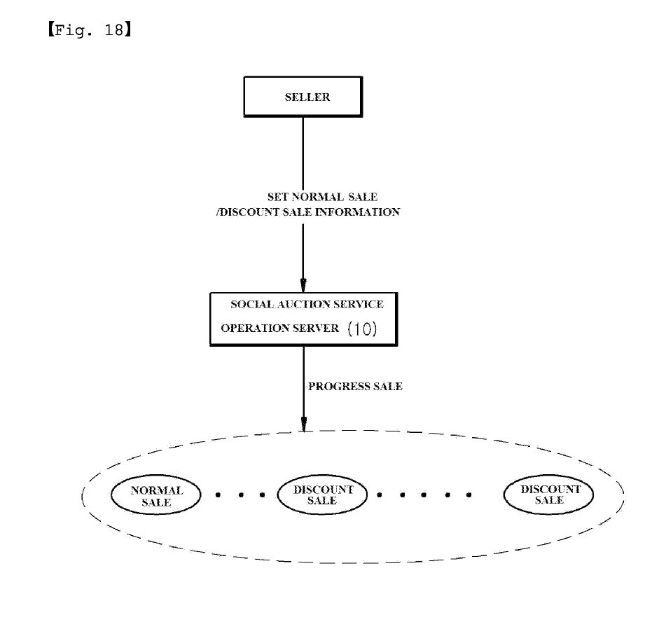

Next, a function and an operation of an on-line sales system using a social auction according to a ninth embodiment of the present invention will be described in detail with reference to the accompanying FIG. 18.

FIG. 18 is a block diagram schematically illustrating an operating principle of the on-line sales system using a social auction according to the ninth embodiment of the present invention.

Referring to FIG. 18, the on-line sales system using a social auction according to the ninth embodiment of the present invention repeatedly performs automatically a normal sale and a discount sale when a portion of the margin generated at the time of allowing the seller to sell products above a preset number is used as the promotional costs.

To this end, the social auction service operation server 10 included in the on-line sales system using a social auction according to the ninth embodiment of the present invention performs discount processing on a price to sequentially sell the preset number as the preset discount price when the sale number set by the seller is sold as a normal prices. That is, in order to alternately process the normal sale and the discount sale, the fluctuation price information and the price determination variable information may be set together and the social auction service operation server 10 may act on the behalf of sale based on the preset number and the price.

In particular, the social auction service operation server 10 is effectively operated in the open market, and the like, which is a sale space on the Internet performing the electronic payment and thus may alternately process the normal sale and the discount sale.

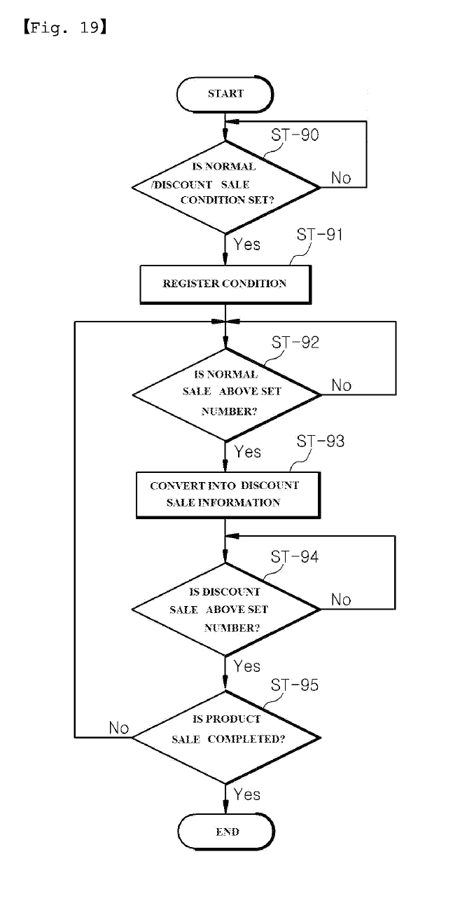

FIG. 19 is a flow chart illustrating processing processes of the on-line sales system using a social auction according to the ninth embodiment of the present invention.

First, describing in detail the system described with reference to FIG. 18, the social auction service operation server 10 included in the on-line sales system using a social auction according to the ninth embodiment of the present invention determines whether a condition signal alternately repeating the normal and discount sales is received.

That is, the seller may set the condition signal alternately repeating the normal and discount sales in the social auction service operation server 10 using the seller terminal 4 and the social auction service operation server 10 receives the condition signal and registers therein.

Herein, the condition signal alternately repeating the normal and discount sales means the setting condition for the products sold at the time of the normal sale and the discount sale.

For example, when the seller provides 10% of the margin obtained at the time of the normal sale as the promotional costs and is going to perform a sale by discounting the produces to 20%, the sale condition may be set in the social auction service operation server 10. That is, when 40 products are sold at the normal sale, in order to discount and sell 10% of the margin as the promotional costs, the sale condition to discount and sell a total of 20 products by 20% may be set.

In the state in which the setting is established, the social auction service operation server 10 determines whether the products is normally sold above a preset number and when the preset number or more of the products is sold, the number of products to be discounted and sold is calculated depending on the setting of the seller to change the information of the seller to the discount sale information.

In the case of the open market, the social auction service operation server 10 may simply change the sale information of products.

In this state, the social auction service operation server 10 determines whether all the discount sales of the products is completed, that is, determines whether all the normal sale and discount sale products are sold. In this case, when all the products are sold, the sale of the seller ends.

When the products to be sold still remains, the social auction service operation server 10 alternately repeats the normal sale and the discount sale depending on the setting sale conditions.

While the present invention has been described with reference to the preferred embodiments, it will be understood by those skilled in the related art that various modifications and variations may be made therein without departing from the scope of the present invention as defined by the appended claims.

1. An on-line sales system using a social auction system, comprising:
a purchaser terminal which generates a purchase signal of a divided purchase ticket for participating in an auction to receive a discount rate supported based on a future purchase for products and an auction participating signal;
a seller terminal which performs an issuance request for issuing the divided purchase ticket based on the future sale to a purchaser, and registers a sale information on a product and sale conditions thereof; and
a social auction service operation server configured to sell the divided purchase ticket issued by each seller as a social auction participating condition, register a purchaser information, generate auction numbers for each divided purchase ticket to register therein, and perform an auction process.

2. The system of claim 1, wherein the divided purchase ticket includes: a brand divided purchase ticket which stipulates a future purchase for a specific product; and
a free divided purchase ticket which stipulates a future purchase for an unspecific product.

3. The system of claim 1, wherein the social auction participating condition includes a viewer who watches an advertisement at a specific time or for a specific product.

4. The system of claim 1, wherein the social auction uses a cost including at least one of a sale price of the brand divided purchase ticket and the free divided purchase ticket and a promotional cost of a seller as a financial resource of a successful bid price.

5. The system of claim 1, wherein the social auction service operation server is configured to register a successful bid discount rate of a brand product and a basic discount rate of the brand divided purchase ticket in an account of a successful bidder participating in an auction using the brand divided purchase ticket, and register a basic discount rate of the free divided purchase ticket and a successful bid discount rate converted into cash of the brand product in an account of a successful bidder participating in an auction using the free divided purchase ticket.

6. The system of claim 1, wherein the free divided purchase ticket is a purchase ticket to be used to purchases only the products of specific sellers previously registered in the social auction service operation server.

7. The system of claim 1, wherein the social auction service operation server is configured to generate a social auction number and provide the generated social auction number to the purchaser of the divided purchase ticket and allow a purchaser having the same social auction number to participate in the same auction and generate only a one-time bid signal in the same auction.

8. The system of claim 1, wherein the social auction service operation server is configured to register a setting information on the seller so as to determine that the social auction starting conditions are satisfied only when the number of purchasers of the brand divided purchase ticket is within a predetermined range, and determine whether an auction starts based on the registered setting information.

9. The system of claim 1, wherein the social auction service operation server is configured to convert all divided purchase tickets sold before the social auction starts into an accumulated discount rate for the specific products, and display the converted discount rate on a screen so that a purchaser confirms the converted discount rate.

10. The system of claim 1, wherein the social auction service operation server is configured to display an overall remaining accumulated discount rate updated by subtraction due to the generation of a successful bidder during the progress of the social auction on a screen so that the purchaser confirms the updated overall remaining accumulated discount rate.

11. The system of claim 4, wherein the brand divided purchase ticket or the free divided purchase ticket corresponds to a predetermined ratio of a sale price thereof to a sale price of a designated product.

12. The system of claim 1, wherein the seller registers an additional discount rate information in the social auction service operation server to provide an additional discount rate to each of the purchasers of the brand divided purchase ticket.

13. The system of claim 4, wherein the seller provides a cost for the specific number of sale products as the financial resource for the social auction, and
the social auction service operation server is configured to previously designate and provide the specific number of sale products so that the successful bid processing on the specific number of sale products is performed within a limited discount range for each product.

14. The system of claim 1, wherein the purchaser registers a bid reservation information on the social auction in the social auction service operation server in advance.

15. The system of claim 1, wherein the social auction service operation server is set to allocate a first successful bid right to a successful bidder within a local range so that a purchaser residing in an area other than the local range is selected as a successful bidder when the successful bid fails more than a predetermined number of and process the auction, when the seller designates a local social auction.

16. The system of claim 1, wherein the social auction service operation server is configured to automatically increase the discount rate for the product as time progresses after the auction starts, determine that the successful bid for the discount rate is made depending on a user's selection signal for a specific discount rate, and subsequently increase the discount rate for a purchaser which has not generated a bid signal.

17. The system of claim 1, wherein the social auction service operation server is configured to automatically increase the discount rate for a product as time progresses after the auction starts, end the auction when a successful bid for the discount rate is made depending on the user's selection signal for the specific discount rate, and when the remaining accumulated discount rate is present, progress a new auction for a purchaser which has not generated a bid signal.

18. The system of claim 1, wherein the social auction service operation server is configured to continuously progress the social auction as long as the remaining discount rate continues to increase, and be updated, due to a successful bid.

19. The system of claim 1, wherein when the purchaser purchases the product with cash for a value for which the basic discount rate and the successful bid discount rate held by the successful bidder successfully bidding through the auction due to the free divided purchase ticket are converted, the social auction service operation server is configured to register a use limitation range for the discount rate of the seller by allowing the seller of the product to use the basic discount rate only within a previously limited discount rate, and compare the free divided purchase ticket information held in the purchaser account with the registered use limitation range and perform a subtraction processing based on the compared results.

20. The system of claim 6, wherein the social auction service operation server is configured to post a limitation of the discount price of the available free divided purchase tickets for each seller so that the purchaser reads the limitation.

21. The system of claim 1, wherein the divided purchase ticket has an expiration date set at the time of the issuance thereof.

22. The system of claim 1, wherein the social auction service operation server is configured to pay an additional discount price depending on a purchase frequency of the divided purchase tickets of each purchaser.

23. The system of claim 1, wherein the social auction service operation server is configured to provide a product package brand purchase ticket to which the discount rate is applied when products sold by a single company are simultaneously purchased, a company package brand purchase ticket to which the discount rate is applied when products sold by a plurality of companies are simultaneously purchased, and an area package brand purchase ticket to which the discount rate is applied when products of companies within a specific area are purchased.

24. The system of claim 23, wherein a selection of a seller participating in the product package brand purchase ticket, the company package brand purchase ticket, and the area package brand purchase ticket is determined by an agreement of other sellers participating together with them in the auction.

25. The system of claim 23, wherein the product package brand purchase ticket, the company package brand purchase ticket, and the area package brand purchase ticket have an independent discount price or discount rate applied thereto.

26. The system of claim 1, wherein the social auction service operation server is configured to replace the brand divided purchase ticket and the free divided purchase ticket depending on the agreement of the seller and the purchaser when all the accumulated discount rates for the brand divided purchase ticket and the free divided purchase ticket are not used up.

27. The system of claim 26, wherein the social auction service operation server is configured to sell the brand divided purchase ticket and the free divided purchase ticket successfully bidden at a specific discount rate to a new purchaser.

28. The system of claim 1, wherein the social auction service operation server is configured to approve an issuance of a gift divided purchase ticket for giving the brand divided purchase ticket and the free divided purchase ticket to a third party, and process a purchaser information together with an owner account information of the gift divided purchase ticket so as to equally apply the discount price applied to the purchase of the successful bidder at the time of the successful bid of the social auction to the purchaser using the gift divided purchase ticket.

29. The system of claim 1, wherein the social auction service operation server is configured to set a sale price of the divided purchase ticket, a promotional cost of the seller, and an advertising cost of an advertiser as the financial resource of the social auction, determine whether the successful bidder views advertisement for a product, and process the advertising costs to allocate an additional incentive to the successfully bidden discount price when the successful bidder views the advertisement.

30. The system of claim 1, wherein the social auction service operation server is configured to discount a price so that a predetermined number is sold at a preset discount price when the sale number set by the seller is sold at a normal price, and set both of fluctuation information and price determination variable information to alternately process a normal sale and a discount sale.

31. The system of claim 30, wherein the social auction service operation server is configured to act on the behalf of the sellers for products committed by the sellers.
